(19) United States
(12) Patent Application Publication
(10) Pub. No.: US 2005/0250472 A1
(43) Pub. Date: Nov. 10, 2005

(54) User authentication using a wireless device

(76) Inventors: Kelan C. Silvester, Portland, OR (US); Francis X. McKeen, Portland, OR (US); Sundeep Bajikar, Santa Clara, CA (US); Luke Girard, Santa Clara, CA (US)

Correspondence Address: Issac T. Lin;Blakely, Sokoloff, Taylor & Zafman LLP, 12400 Wilshire Boulevard, 7th Floor, Los Angeles, CA, 90025, US

(21) Appl. No.: 10/839,271

(22) Filed: May 4, 2004

(51) Int. Cl. H04L 9/00

(52) U.S. Cl. 455/411

(57) ABSTRACT

A method for providing security to a computer system is described. Specifically, the computer periodically polls for a Bluetooth electronic device or other similar wireless electronic device. If the computer locates such a Bluetooth electronic device, the computer requests authentication from the Bluetooth electronic device. The user of the electronic device is given access to the computer system only if the computer recognizes the identification of the Bluetooth electronic device and is able to validate the authentication information provided by the Bluetooth electronic device through an encrypted channel.

### FIELD OF THE INVENTION

The present invention pertains to the field of computer system design. More particularly, the present invention relates to a method of using a wireless device for providing a computer user's authentication.

### BACKGROUND OF THE INVENTION

Computers may communicate with other computers in a number of ways. First, a computer may be directly connected to another computer. Second, each of the computers may be wired to a single central computer. This central computer may act as a mainframe. Third, computers may be connected to one another through a local area network (LAN). The computers on a LAN are connected by a communications link that enables any device to interact with any other on the network. Fourth, several LANs may be linked together into a wide area network (WAN). Through a WAN, all the computers in each LAN communicate over an inter-LAN link to any of the other computers in any of the other connected LANs.

Computers have traditionally been connected to one another through wired connections. For example, the connection may be made using an Ethernet or a universal serial bus (USB) cable. Wireless links, however, enable computers to communicate with each other without a cable. Wireless links are made possible through wireless protocols such as wireless local area network (WLAN), wireless wide area network (WWAN), and Bluetooth.

### BRIEF DESCRIPTION OF THE DRAWINGS

FIG. 1 is an embodiment of a computer system for protecting against unauthorized access to a computer;

FIG. 2 is a flowchart of a procedure for polling for wireless electronic devices; and

FIG. 3 is a flowchart of a procedure for authenticating a computer user.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

A computer system or a computer network may have confidential applications and data stored in the system's memory or on a mass storage device. To prevent unauthorized access, most computer systems only require the user to provide a username and a password. The username and password is then matched against a database of authorized usernames with corresponding passwords. Thus, a person who wishes to steal confidential information from a computer system would only need the owner's username and password to gain access. A variety of unscrupulous methods exist to steal or alter the username and password for malicious intent. Additional levels of protection would help to prevent theft of confidential information of a computer system.

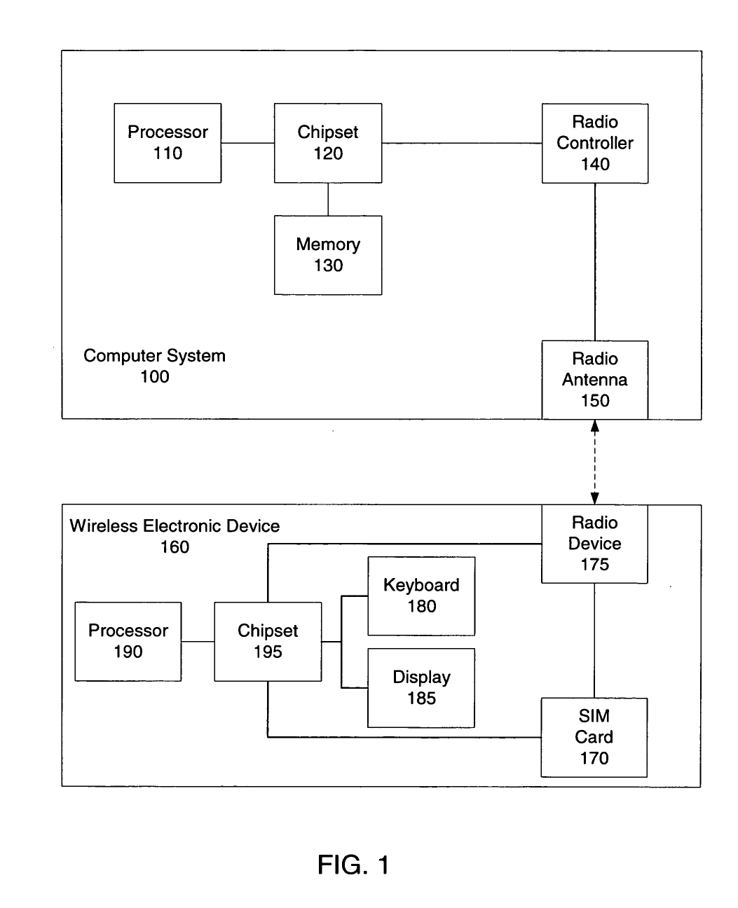

A wireless electronic device may be used to provide additional protection against unauthorized access to a computer and its data. FIG. 1 depicts a computer system 100 that requires a wireless electronic device 160 to provide certain user authentication information before a user is given access to the computer system 100. The computer system 100 may comprise a processor 110. The processor 110 may be coupled to a chipset 120. The chipset 120 may be coupled to a memory 130 and a radio controller 140 through a Universal Serial Bus (USB) or a Peripheral Component Interconnect (PCI) bus. The chipset 120 may communicate data and control signals between the processor 110 and memory 130 and the radio controller 140. The radio controller 140 may be coupled to a radio antenna 150. The radio antenna 150 communicates data to and from the computer system 100 to a wireless electronic device 160.

The wireless electronic device 160 may comprise a processor 190. The processor 190 may be coupled to a chipset 195. The chipset 195 may be coupled to a keyboard 180, a display or screen 185, a SIM card 170, and a radio device 170.

For one embodiment of the invention, the wireless electronic device 160 may be a Bluetooth electronic device. Bluetooth is a short-range wireless communication specification for connecting electronic devices.

For another embodiment of the invention, the wireless electronic device 160 may be a WLAN compatible device.

For yet another embodiment of the invention, the wireless electronic device 160 may be a WWAN compatible device.

The keyboard 180 provides a user of the wireless electronic device 160 with an interface to the SIM card 170. For example, the user may request to read data from the SIM card 170 by pressing certain keys of the keyboard 180. The requested information may then be made available on the screen 185 by the processor 190 and the chipset 195.

The user may be required to enter a specific character sequence, such as a password or a personal identification number (PIN), before the wireless electronic device 160 grants access to data found on the SIM card 170. If the wireless electronic device 160 is a mobile phone, the required character sequence to be entered into the keyboard 180 may be a Global System for Mobile (GSM) PIN. Further, a mobile phone may comprise device firmware to use GSM protocols to access data from the SIM card 170.

The wireless electronic device 160, however, is not limited to being a mobile phone. For example, the wireless electronic device 160 may be a badge, keyfob, or any other mobile device that connects wirelessly to the computer system 100.

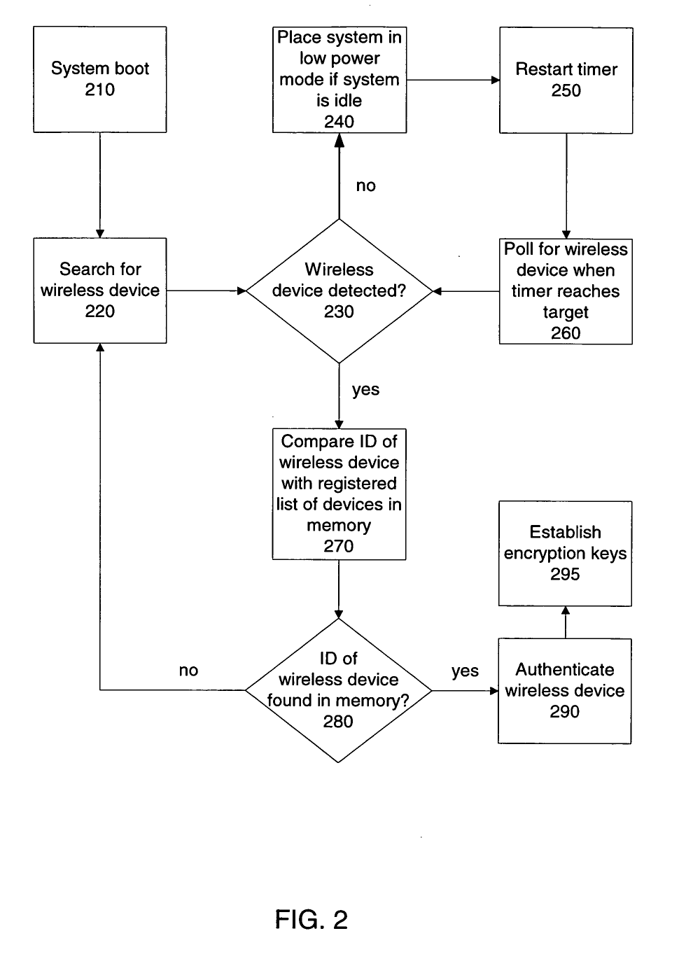

The computer system 100 may communicate with the wireless electronic device 160 via radio signals transmitted between the radio antenna 150 of the computer system 100 and the radio device 175 of the wireless electronic device 160. Before the wireless electronic device 160 may provide authenticating information, the computer system 100 must locate the wireless electronic device 160. For one embodiment of the invention, FIG. 2 depicts a procedure for polling for wireless electronic devices that are in the vicinity of the computer system 100.

The computer system 100 starts up in operation 210. The processor 110 then polls for a wireless device in operation 220. The processor 110 may accomplish this task by executing software code in a device driver running on the host processor 110. The device driver may then issue the command to a radio antenna 150 to poll for wireless electronic devices through a radio controller 140. If a wireless electronic device 160 is detected in operation 230, the processor 110 compares the identification of the wireless electronic device 160 with a registered list of devices stored in memory 130 in operation 270. Bluetooth and other wireless electronic devices may have a unique identification. If the identification of the wireless electronic device 160 is found in memory 130 in operation 280, the wireless electronic device 160 is authenticated in operation 290.

The authentication of operation 290 is recommended even though the wireless electronic device 160 is on an approved list of electronic devices because a wireless electronic device identification can be spoofed to purposely match a device identification with a host computer. To address the problem, the wireless electronic device 160 may establish an encrypted channel with the computer system 100 in operation 295. Using the encrypted channel, authentication information may be transmitted from the wireless electronic device 160 to the computer system 100 without concern for malicious attack to alter or steal the authentication information in transit.

For example, if the wireless electronic device 160 supports the Bluetooth wireless protocol, a Bluetooth encrypted communications channel is established. Then, the wireless electronic device may deliver an authentication credential or certificate digitally signed by a Trusted Third Party (TTP) such as Verisign or Entrust. For additional protection and validation, user credentials transported across the encrypted wireless link may include a hash value, such as the SHA-1 hash, that can be used to determine if the user credentials have been maliciously or erroneously altered in transit.

Establishment of the encrypted channel requires use of a session key exchange algorithm defined to industry standards. The encryption method may use standards such as AES, DES, 3DES, or other methods using asynchronous or synchronous encryption keys. Establishment of the encryption keys used for this encrypted channel is done through standards and algorithms defined in the cryptographic community.

If a wireless electronic device is not detected in operation 230, the computer system 100 is placed in a low power mode in operation 240 if the computer system 100 is idle. The low power mode helps the computer system 100 reduce power consumption and extend battery life. Next, the processor 110 restarts a timer or a counter in operation 250. The timer has a predefined target.

For one embodiment of the invention, the timer target is 490 milliseconds. When the timer reaches the target, the processor 110 sends a request to the radio antenna 150 through chipset 120 and radio controller 140 to poll for wireless electronic devices in operation 260. The poll time may be for 10 milliseconds. Thus, for this embodiment of the invention, the processor 110 polls for available wireless electronic devices for 10 milliseconds twice every second.

After polling for wireless electronic devices in operation 260, the processor 110 again checks whether a wireless electronic device has been detected in operation 230. The radio antenna 150 may transmit a signal having a range of up to 10 meters. The distance for effective operation between the radio antenna 150 and the radio device 175 may be a function of the radio type and the power supplied.

The data transmission bit rate for data returned to the reader may be derived by a synchronized clock source. The synchronized clock source may be received by the radio controller 140. The radio controller 140 may then generate an internal clock by dividing the frequency of the synchronized clock source.

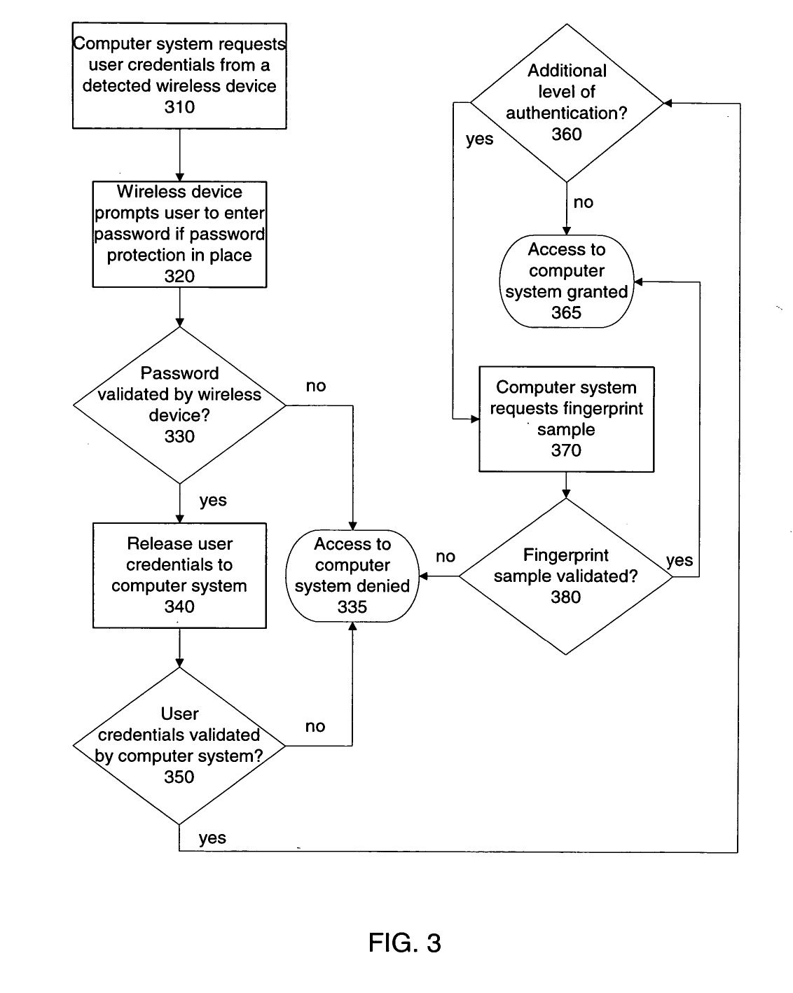

FIG. 3 depicts a method for authenticating a computer user once a wireless electronic device 160 is detected within the range of the radio antenna 150. The processor 110 of the computer system 100 establishes a Bluetooth link if the wireless electronic device 160 is a Bluetooth electronic device. The wireless electronic device 160 then acknowledges the encrypted Bluetooth link request. Other methods of encryption may also be used as an alternative to the intrinsic Bluetooth encryption channel mechanism. The computer system 100 requests user credentials from the detected wireless electronic device 160 in operation 310. The request may include a public encryption key of the owner of the computer system 100 and an authentication certificate for the computer system 100. Alternatively, the computer system 100 may include a public encryption key generated just for this specific wireless link with wireless electronic device 160. The use of public/private key asymmetric encryption of transmitted data across the wireless link helps to protect the transmitted data.

The public key encryption can only be decrypted with a matching private key. While the computer system 100 may freely distribute the public key, the private key is not revealed. The size of the keys may range from 512 bits to 2048 bits. The strength of the encryption depends on the encryption algorithm with the size of the encryption key. For one embodiment of the invention, the encryption algorithm is RSA. Encryption keys used to establish an encryption channel may be delivered through methods such as Diffie-Hellman or other mechanisms.

Alternatively, the computer system 100 and the wireless electronic device 160 may be haven provisioned with a common symmetric encryption key of adequate key length, such as 128-bits, 192-bits, or 256-bits. This symmetric encryption key is kept private and never shared outside of the device, and can be used to provide a secure encryption channel using symmetric encryption algorithms such AES.

The computer system 100 may also provide an authentication certificate when requesting for user credentials in operation 310. This would allow the wireless electronic device 160 to authenticate the computer system 100. Without this level of authentication, wireless electronic device 160 may lack reasonable justification for releasing the user's credentials to the computer system 100.

If the wireless electronic device 160 has a password protection scheme in place as determined by configuration settings found on the SIM card 170, the wireless electronic device 160 prompts the user to enter a password in operation 320. The user then enters the password into the wireless electronic device 160 using the keyboard 180. If the password entered by the user is not correct in operation 330, access to the computer system 100 is automatically denied in operation 335 because the wireless electronic device 160 ceases to make further communications with the computer system 100.

The wireless electronic device 160 may require the user to provide other forms of user authentication before the user credentials are released to the computer system 100. The wireless electronic device 160 may include a method to measure biometric characteristics of the user, such as fingerprint or face scan. The user enrolls his biometric characteristic. For example, the user may touch a fingerprint sensor on the wireless electronic device 160. The wireless electronic device 160 then securely stores the biometric template. Subsequent authentication attempts may require matching a newly captured biometric template against the enrolled template to validate the user.

If the password is validated by the SIM card 170 in operation 330, the wireless electronic device 160 releases user credentials to the computer system 100 in operation 340. The computer system 100 receives the authentication certificate and validates the user credentials in operation 350. The authentication certificate or credentials may be protected by a public or private key encryption to prevent the threat of alteration or theft during data transmission. The public key may have been defined and exchanged during a first-time connection or configuration between the computer system 100 and the wireless electronic device 160. The configuration may be provisioned in the factory before the computer system 100 is shipped to the consumer, or by a corporate information technology (IT) department to contain the correct public/public key pairs to protect the data transmission and validate the authentication credentials.

During the configuration session, the user may have been prompted for his acknowledgment to transfer public keys and user credentials from the wireless electronic device 160 to the computer system 100. This acknowledgment may have required for the user to enter the password on the wireless electronic device 160 and a similar acknowledgement on the computer system 100. Having the user consciously approve the key exchange may help reduce the chance of a malicious entity requesting user credentials from the wireless electronic device 160 by simply making a request and providing a public key.

After exchanging public keys, the keys can be used to encrypt authentication data that may only be decrypted by the owner of the private key. For example, the wireless electronic device 160 may have the public key of the computer system 100. When requested to deliver user credentials, the wireless electronic device 160 can use that public key to encrypt the user credentials and send it to any system that requests the data. Only the legitimate owner or user of the computer system 100 will be able to decrypt the user credentials since only the computer system 100 has the matching private key used for decryption.

Once the response is received by the computer system 100, the wireless link is terminated. The computer system 100 decrypts the response from the wireless electronic device 160 and then validates the user credentials. The user credential may be a x.509 certificate. If the computer system 100 is unable to validate the user credentials received from the wireless electronic device 160, access to the computer system 100 is denied.

If the computer system 100 successfully decrypts and then validates the user credentials received from the wireless electronic device 160, the computer system 100 checks for additional levels of authentication in operation 360. If there are no further levels of authentication, then access to the computer system 100 is granted in operation 365.

For one embodiment of the invention, the computer system 100 requests for a fingerprint sample in operation 370 as an additional level of authentication. If the fingerprint sample is validated in operation 380, the user is granted access to the computer system 100 in operation 365. However, if the fingerprint sample is not validated in operation 380, access to the computer system 100 is denied in operation 335.

For another embodiment of the invention, the computer system 100 requests for a password in operation 370. If the password is validated in operation 380, the user is granted access to the computer system 100 in operation 265. On the other hand, if the password is not validated in operation 380, access to the computer system is denied in operation 335.

In the foregoing specification the invention has been described with reference to specific exemplary embodiments thereof. It will, however, be evident that various modification and changes may be made thereto without departure from the broader spirit and scope of the invention as set forth in the appended claims. The specification and drawings are, accordingly, to be regarded in an illustrative rather than restrictive sense.

1. A computer system, comprising:
a processor;
a chipset coupled to the processor to deliver data between the processor and a memory; and
a radio controller coupled to the chipset to poll for a Bluetooth electronic device.

2. The computer system of claim 1, wherein the memory comprises a database of approved Bluetooth devices for communication.

3. The computer system of claim 1, wherein the processor establishes an encrypted Bluetooth link if a Bluetooth electronic device is located.

4. The computer system of claim 3, further comprising:
a radio antenna coupled to the radio controller to transmit signals to and from the Bluetooth electronic device.

5. The computer system of claim 4, wherein the radio antenna has a communication range of 10 meters.

6. A computer system, comprising:
means for polling for Bluetooth devices;
means for matching an identification of a located Bluetooth device; and
means for decrypting encrypted data sent by the Bluetooth device.

7. The computer system of claim 6, further comprising:
means for conserving power while polling for a Bluetooth device.

8. The computer system of claim 6, further comprising:
means for establishing a Bluetooth link.

9. The computer system of claim 6, further comprising:
means for authenticating a certificate sent by the Bluetooth device.

10. A method, comprising:
polling within a 10 meter range for a wireless electronic device;
connecting to a wireless electronic device via a wireless link; and
requesting for an authentication certificate from the wireless electronic device.

11. The method of claim 10, further comprising:
receiving an identification from the wireless electronic device; and
comparing the wireless electronic device identification with a registered list of approved devices.

12. The method of claim 11, further comprising:
establishing an encrypted channel if the wireless electronic device identification is found in a database.

13. The method of claim 11, further comprising:
receiving a user authentication certificate from the wireless electronic device; and
closing the wireless link.

14. The method of claim 13, wherein the user authentication certificate is digitally signed by a Trusted Third Party.

15. The method of claim 13, further comprising:
unraveling the user authentication certificate; and
authenticating the authentication certificate.

16. The method of claim 15, further comprising:
requesting for a fingerprint sample.

17. The method of claim 15, further comprising:
requesting for a password.

18. The method of claim 10, wherein the wireless electronic device is a Bluetooth device.

19. The method of claim 10, wherein the wireless electronic device is a wireless local area network device.

20. The method of claim 10, wherein the wireless electronic device is a wireless wide area network device.
